(19) United States
(12) Patent Application Publication
(10) Pub. No.: US 2010/0242076 A1
(43) Pub. Date: Sep. 23, 2010

(54) SYSTEM AND METHOD FOR PROGRAMMING VIDEO RECORDERS

(75) Inventors: Laurent Potesta, Chernex (CH); Florian Steffen, Renens (CH)

Correspondence Address: PEARNE & GORDON LLP, 1801 EAST 9TH STREET, SUITE 1200, CLEVELAND, OH, 44114-3108, US

(73) Assignee: GETMORE TV SARL, Chernex (CH)

(21) Appl. No.: 12/716,369

(22) Filed: Mar. 3, 2010

Related U.S. Application Data
(63) Continuation of application No. PCT/EP2008/061856, filed on Sep. 8, 2008.

(30) Foreign Application Priority Data
Sep. 7, 2007 (CH) 01396/07

(51) Int. Cl. H04N 7/173; H04N 5/91

(52) U.S. Cl. 725/109; 386/83; 386/E05.003

(57) ABSTRACT

The invention relates to a method for programming video recorders (5, 7, 9) that comprises the following steps:
selecting a piece of video content (E1-E6) to be recorded, the selection being made by a user by means of an electronic program guide presented by a server (1);
including an indication of said video content in a theme grouping one or more pieces of content on a same subject;
selecting the users with a subscription to said theme;
automatically transmitting programming instructions to the video recorders (5, 7, 9) of the users with a subscription to said theme.

The present application is a continuation of PCT/EP2008/061856, filed on Sep. 8, 2009, the content of which is enclosed by reference. It claims priority of Swiss Patent Application CH01396/07, filed on Sep. 7, 2007, the content of which is enclosed by reference.

### TECHNICAL FIELD

The present invention concerns a method for remotely programming video recorders as well as a server adapted for this process.

### STATE OF THE ART

There are many devices for recording television programs in order to watch them at a chosen time. Video cassette recorders are slowly being replaced by recorders on optical disks or hard disks. Other recording media, including systems making it possible to record on a remote medium, continue to be developed.

The user wishing to record a program must enter a command in advance in order to indicate to the video recorder to start and interrupt the recording of the selected channel at the desired time. This operation is called programming (scheduled recording). Various methods and devices have been developed and continue to be developed to make this operation as user-friendly as possible.

However, the number of television channels available to viewers tends to increase fast so that it is more and more difficult to know which channel is showing which program at which time. The available channels further depend on the cable operators and on the network packages subscribed to by each viewer. Television magazines printed on paper, although they continually increase in size, are no longer sufficient for presenting the whole available range on offer.

In order to resolve this problem, electronic program guides (EPG) are also known. EPGs make it possible to display several weeks in advance the programs shown by several channels on one or several web pages accessible from an Internet browser or directly on the television. Search and classification tools make browsing easier and allow a viewer to find more quickly those programs that are likely to be of interest.

Patent application WO0161997 describes a system that enables a programmable video recorder to be remotely programmed from any web browser. The viewer wishing to schedule the recording of a program selects it from his browser out of an electronic program list. The server displaying this EPG encodes the programming instructions with an identification of the decoder encapsulated in the video signal broadcast to all viewers. A decoder linked to the viewer's television receiver receives these instructions, detect that they are intended for it, and executes these instructions. A similar solution is also described in WO0140887.

In order to make the scheduled recording of programs even easier, patent application WO0147273 proposes an automatic program recommendation system based on correlations between user profiles and the characteristics of the program. The viewer is thus automatically informed about programs likely to be of interest. It is however difficult to determine automatically and reliably the preferences of the viewers, especially if the choice of program is very wide.

WO2004032511 describes a programming server allowing a user to remotely program a digital video recorder, for example from a computer connected to the Internet. The user can connect via Internet to the server to define a choice of programs to be recorded and then transfer these choices to a video recorder. The system however requires that the user should first connect to the server, for example by means of a PC connected to the Internet, in order to select the programs or categories of programs to be recorded. Furthermore, a user who discovers an interesting program has no possibility for scheduling the recording of this program on recorders not belonging to him, or for easily recommending this program to friends or acquaintances.

US20050149987 describes a system allowing a community of viewers to share information relating to programs. A selection of links to television programs can be shared through websites, blogs or emails, and loaded into a video recorder to initiate programming. This method thus makes it possible to transmit to friends or on the Internet identifications of interesting programs.

In this document, digital video recorders can be programmed comfortably by means of links the users can select. These links can have different formats, for example a complete description of the program like the one appearing in an EPG or a format similar to a Universal Resource Locator (URL) used to identify an Internet location.

A user of this system can transmit a programming link to other users, for example via email or by depositing it in a chat space. In the latter case, a chat space moderator wishing to recommend a television program to be recorded must first send an email to all the members of that space, to ask them to connect to the chat and select there the link to the television program to be recorded. The recorders are automatically programmed only if the users connect and select the recommended link. However, the programming is not updated if the user does not read his emails and does not connect to the chat server. The scheduled recording of new programs proposed in an email or a chat forum thus in all cases requires an intervention from the user.

This solution does not allow the recorder of an absent user or of a user who forgets or refuses to connect to the chat server to be programmed remotely. Furthermore, this method is too complex for many people who do not know how to connect to a chat server or who do not have an active email address.

The website http://web.archive.org/web/20070714195654/-http://www3.tivo.com/tivo-tco/mix/index.do, extracted on 28 Jan. 2008, describes a method enabling a “guru” to manually select lists of programs proposed to users. A user wishing to follow a guru's recommendations must view the series of lists proposed by different gurus, then manually subscribe to a list of recommendations from among the different proposed lists. The document does not provide information on the manner in which the program identifications in the selected lists are transmitted to the users' recorders; it is for example unknown whether an intervention from the user is required during this transfer. Furthermore, the described method does not allow any user of a video recorder to program his friend's recorders; only a limited number of “gurus”, apparently specialists or celebrities selected by the manufacturer, can propose program lists. These lists are however accessible to all users and even the gurus have no possibility of restricting access rights to their list.

Other methods and systems for programming digital video recorders are also described in documents WO0147249, US20050120370, WO03098932 and WO2006051492.

Furthermore, one also knows “social web”-type applications that allow Internet users to share photos, for example on www.flickr.com, videos for example on www.youtube.com, or other types of documents. “Youtube” for example enables any Internet user to make available to the public or to other Internet users any kind of video content. This solution however requires that the Internet user wishing to make a video document available to other users has a copy of that document, which is not the case before this video has first been broadcast. Furthermore, storing and providing copies of video contents raises copyright problems that limit the possibilities for distribution.

### BRIEF SUMMARY OF THE INVENTION

One aim of the present invention is to propose a system and a method for programming video recorders improved over the prior art methods.

According to the invention, these aims are achieved notably by means of a method for programming video recorders comprising the following steps:

a piece of video content to be recorded is selected by an editor-user of a video recorder,

an indication of said video content is included in a theme grouping one or more pieces of content, for example on a same subject,

the users with a subscription to said theme are selected,

programming instructions are automatically transmitted to the video recorders of the users with a subscription to said theme,

the video recorders of said users being programmed with said instructions without any intervention from the users.

These steps can be executed in the order listed above or in another order.

The selection of the contents can be performed in an EPG or by entering manually or automatically an indication of the program and/or a date and a time for the beginning and the end of the program.

This solution has notably the advantage over the prior art of enabling any user-editor to automatically program the video recorders of other users with a subscription to a same theme. Conversely, a user can program his recorder to receive all video contents linked to a theme of interest, simply by subscribing to this theme and trusting the selections made by the editor. Any user can furthermore create new themes, include programs in this theme, invite other users to subscribe and/or define the rights of other users to see this theme, to see the contents of this theme, to subscribe thereto or to modify the theme's contents.

The term video recorder is understood to refer to any device or system capable of durably memorizing a video signal on a support of any type, including a recorder on tape, on hard drive, on optical disk, computer, PDA or mobile phone for example.

When subscribing to a theme, a user thus delegates to the administrator or to the different administrators of the theme the right to program his video recorder. This right can potentially be delegated to any other user, without being limited to a particular class of users or gurus. Conversely, an editor-user can program the video recorders of any other user subscribing to a theme administered or edited by this editor-user.

When a user has subscribed to a theme (further to an action on his part or to an invitation), his video recorder is preferably programmed entirely automatically and without intervention on his part, including when new programs are added to the theme. In one embodiment, the programming of at least some programs, or of all programs, or the resolution of conflicts, requires or allows the user to intervene to confirm or cancel a scheduled recording.

This solution thus combines the advantages of a system for programming video recorders from the web with features of a “social web”-type application enabling Internet users to share and define rights to selections of video content to be recorded. It generally allows copyright problems to be avoided since the video contents are stored by the users themselves and for their own use; only the programming instructions are published.

The method of the invention offers the advantage of enabling users to form communities around a subject or a series of programs and to share their selection of video content on a theme with the public or with closed user groups, for example affiliated or related users on a social network system. Users thus generally trust the content of the proposed themes more, because this content comes from known or related users; it is therefore easier for a user to authorize an entirely automatic programming of his recorder device by a third party without necessarily requesting each time a confirmation of each program or even of each theme, and without a selection or confirmation by means of a computer being necessary. The received programming instructions are preferably executed directly by the video recorders of the users with a subscription to a theme.

This method also allows any user-editor to share video program selections with a sub-group of other users, without necessarily having to make his programming tastes known to all of the other users. Advantageously, the user-editor can himself authorize or limit the right of the other users to view his themes and/or modify them. Different users of video recorders can thus subscribe to different themes according to their connections in the social network application.

Additional rules, including priority rules, contents censure, age limitations, general indications of desired or refused programs, rules preventing a new program from being recorded when the recorder has reached maximum capacity, etc., can be defined by each user to limit the risk of unwanted scheduled recording via the themes, even when coming from trusted users or within the frame of subscribed themes. By way of example, a user can block the scheduled recording of programs with adult or violent contents proposed in the authorized themes.

The inventive method deals only with the commented indications and lists of video content, without touching the video content itself. The piece of video content can even be transmitted by a channel distinct from the one used for the programming command instructions, and at another time. This makes it possible to use the inventive method for the scheduled recording of encrypted programs that will be for example stored on the recorders in encrypted format and then decoded only when read.

In the following description and claims, a theme is for example a manually edited list of indications of video contents, possibly with comments entered by an administrator or user of the theme and access rights for the users.

### BRIEF DESCRIPTION OF THE FIGURES

Examples of embodiments of the invention are indicated in the description illustrated by the attached figures wherein:

FIG. 1 illustrates a block diagram of the inventive system.

FIG. 2 illustrates diagrammatically the layers of the logic model of the inventive recorders.

FIG. 3 is a diagrammatic screen view of a web page enabling a user to create a new theme.

FIG. 4 is a diagrammatic screen view of an example of EPG (electronic program guide) according to the invention.

FIG. 5 is a diagrammatic screen view of an example of dialog box making it possible to schedule the recording of a program or other video content.

### EXAMPLE(S) OF EMBODIMENT OF THE INVENTION

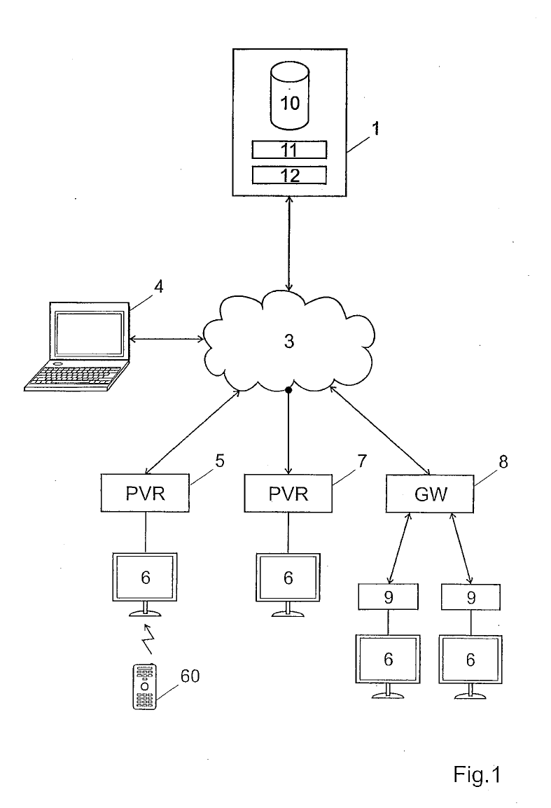

The system illustrated in FIG. 1 includes a central server, for example a web server 1, connected to a communication network 3 such as Internet. The server 1 comprises a database 10 for storing a list of themes and of users having access rights to these themes, as will be seen further below. The database 10 can be constituted by a relational database or a set of XML files for example.

A module 11 enables remote users 4 to access an EPG, for example in the form of web pages, and/or the contents of the database 10, in order to modify the themes or the rights associated with these themes. Another module 12 makes it possible to send video recorder command instructions, as will be seen further below. Again, these instructions can be encrypted in order to avoid third parties intercepting them and determining the viewers' taste.

Programming the video contents to be recorded and the themes in the server is achieved in a privileged way through computers 4 connected to the Internet 3 and accessing web pages presented by the module 11 in order to enter or edit recordings in the database 10. Programming can for example implement tools of the type Java, dotnet, etc. Other means for accessing the database 10, for example from a mobile telephone, a PDA, by SMS, through a voice interface, or directly from the televisions 6, the video recorders 5, 7 or the decoders 9 (set-top box) of the users can be implemented. The programs can be selected from any of these devices, with or without EPG.

The televisions can be conventional analog or digital television receivers or other devices capable of receiving video signals sent in broadcast mode, including mobile phones, PCs, PDAs, etc.

The users have access to a television program emitted continuously and in broadcast mode on their television 6. The television program can be transmitted in analog or digital fashion through any conventional channel, including PAL, SECAM, NTSC, DVB-T, as IP signal on a telephone or other line etc. The transmission of the programs is not affected by the inventive method.

At least one of the users has a digital recorder 5 capable of establishing a bidirectional connection with the server 1 through Internet. The recorder 5 can be combined or associated with a digital decoder and thus enables video contents, for example television programs, to be received, through any channel, and then memorized. The bidirectional connection also makes it possible to send instructions to the server 1, for example programming instructions entered directly on the recorder 5 or by means of the remote control 60. The recorded programs can be displayed on a television set or display 6. The television programs can be received through the same channel 3 used for transmitting the programming instructions or through another channel, not represented in the figure. In one embodiment, the digital recorder 5 has both an interface for a digital or analog television signal and a separate interface of the Ethernet or WLAN type for example to access the Internet.

Other users can have a digital or analog recorder 7 capable of receiving, though not sending, command instructions from the server 1, for example through the Internet. Again, the television programs can be transmitted by the channel 3 or by another channel and displayed on a television set 7.

A third category of users has recorders 9 capable only of receiving a video signal but not directly connected to the Internet. In this case, the instructions for programming the server 1 can be transmitted by Internet to a gateway 8, for example at the cable operator of these users, in order to include them in the video signal, for example as instructions during the flyback or frame interval of an analog signal or as a digital command. The programming command instructions transmitted in broadcast mode with the video signal are associated with an identification of the receiving recorder or decoder so that only this receiver executes them. The instructions can be transmitted immediately after the selection, or be deferred, for example for several hours or several days, but obviously if possible before the program is broadcast.

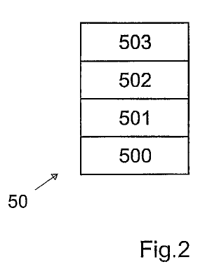

The recorders 5, 7, 9 generally need to be modified to receive and execute the programming command instructions received on the server 1. FIG. 2 illustrates in a simplified manner the interconnection layers 50 of the logic model of a conventional digital recorder. The lowest layer 500 is the physical layer defining the material aspects of the recorder. The layer 501 corresponds to the drivers and administrator software that access this physical layer. The layer 502 is a middleware layer, for example an MHP (Multimedia Home Platform) logic layer in the case of a DVB (Digital Video Broadcasting) recorder. Finally, the layer 503 is an application layer with applications installed for example by the recorder's manufacturer, by a cable operator and/or by the user himself. The inventive decoder is preferably modified at the level of the layer 502 and/or of the layer 503 in order to recognize the programming instructions coming from the server 1 and to execute these instructions.

An example of execution of the inventive programming method will now be described. As indicated further above, the users preferably use a web browser on a personal computer 4 to define new themes, edit existing themes, add or edit indications of video contents in a theme or define access rights to these themes. Access from a mobile telephone, directly from the video recorder or from another device is possible.

The user wishing to avail of or make available to others a list of indications of video content to be recorded will first connect with the browser on a web page presented by the server 1 at a predefined URL address. He is then identified by means of a password or of any other appropriate identification method. This identification enables him to access a personalized page taking into account his profile and his previous choices.

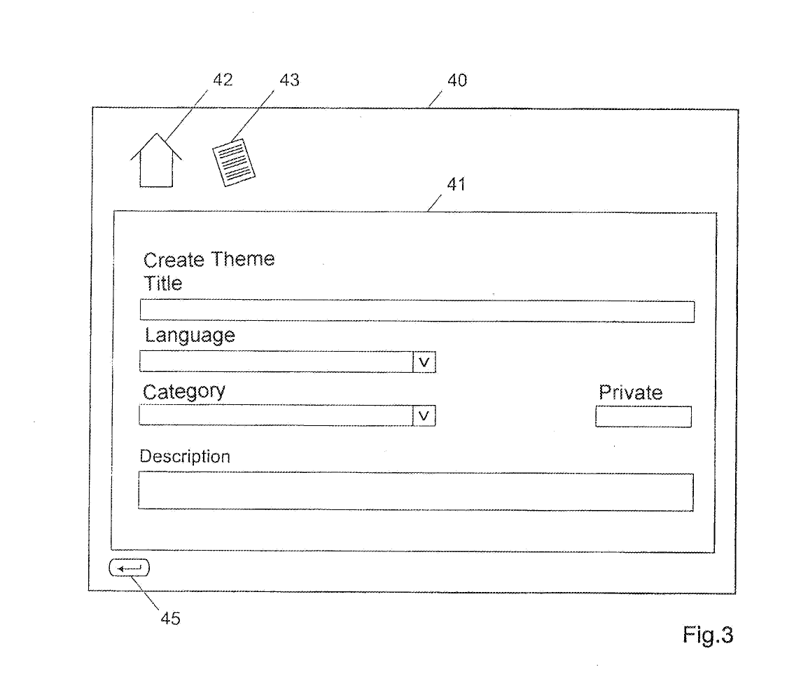

In order to schedule the recording of a piece of video content, the user must first create a theme, i.e. a table or a structure in the database 10 grouping indications of video contents, for example programs, on subjects that are related or likely to interest a same community of users. An example of dialog box 41 on a web page 40 enabling a new theme to be created is illustrated in FIG. 3. The web page includes an icon 42 allowing the Internet user to return directly to a home page and an icon 43 allowing direct access to a conventional EPG.

When the user-editor decides to create a new theme, the dialog box 41 opens and invites the user to indicate a title for the theme (for example “diving”), a language which will be the language of the comments and of most of the programmed video contents, a category (for example “documentary”, “films”, “children” etc.) and a comment or other metadata enabling other users to find this theme more easily and to figure out whether the recorded video contents are likely to be of interest. The name or alias of the user-editor as well as the date of the programming can also be added automatically by the system.

The user can also define access rights to this theme, for example a combination of one or several of the following rights:
Private theme: only the user-editor who creates the theme can see it in the list of themes, add or delete video content indications, comment the theme or the video contents, see the list of programmed video content list or use this list to program a recorder.
Public theme: all users can see the theme in a list of themes and choose to subscribe to it to automatically schedule the recording of the video contents listed in this theme.
Semi-public theme: the user-editor who creates this theme limits its access to a closed group of users, for example a group of friends or family. Access to this theme is thus possible upon invitation or selection on the part of the theme's user-editor or of another user authorized to administer the theme. The users thus invited to a theme must preferably confirm this subscription, unless they have defined in their preferences that they waive this confirmation and accept to be included automatically in all the themes to which they are invited or in all the themes to which they are invited by trusted users, for example friends in a social network system.
A user search engine can be included in the system in order to allow other users identified by their name or by an alias to be easily found. Users preferably also have the possibility to remain anonymous in the system and to not have their name or alias appear in the user lists; they can also choose to restrict the information made available to the other users.

In the case of a public or semi-public theme, the user-editor who has created the theme can grant more or less extensive rights to all the other users or to certain specified users, for example by granting or refusing the following rights:
The right to see the theme or the content of the theme. A user can for example choose to offer a theme visible only to his friends, his family, himself, his clients, etc.
The right to add video content indications to a theme.
The right to delete a video content indication from a theme.
The right to comment a theme.
The right to comment or post a note on a piece of video content selected in a theme.
The right to invite other users to the theme.
The right to modify the rights of the other users.
The right to see the name or the alias of the theme's editor.
Etc.

The theme is then created and stored with its attributes in the database 10 when the user selects the button 45. A web page, not represented, preferably allows a user to consult the list of themes to which he has access or for which he is an editor as well as the list of video contents programmed in each theme, and to modify or edit the themes and/or the list of users of the theme for which he has suitable access rights. Another page, not represented, makes it possible to perform searches on keywords, by category, by language etc. among the public themes to which a user can subscribe and to subscribe to those themes that are of interest in order to automatically record the video contents listed in the theme.

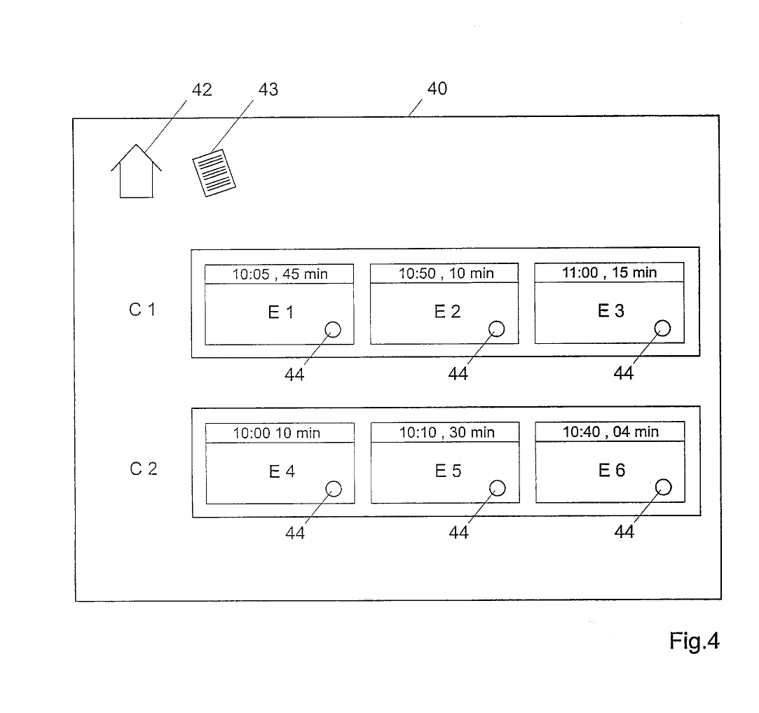

FIG. 4 illustrates an example of EPG shown by the server 1 when the user clicks on the icon 43. The guide indicates the list of video contents, for example television programs, E1, E2 . . . to E6 shown by different channels C1, C2 to which the user has access. Information is displayed about each item of video content, including for example the starting time, the length, the category (film, documentary etc.), a summary, a photo etc. The EPG displays for example three weeks of programs in advance. The list of channels proposed can be limited manually or automatically to those channels that the user can effectively access, notably if the user or his cable operator has indicated this list in the user profile. A button 44 close to the zone reserved to each program allows the recording to be programmed in all the recorders of the users with a subscription to the theme in question.

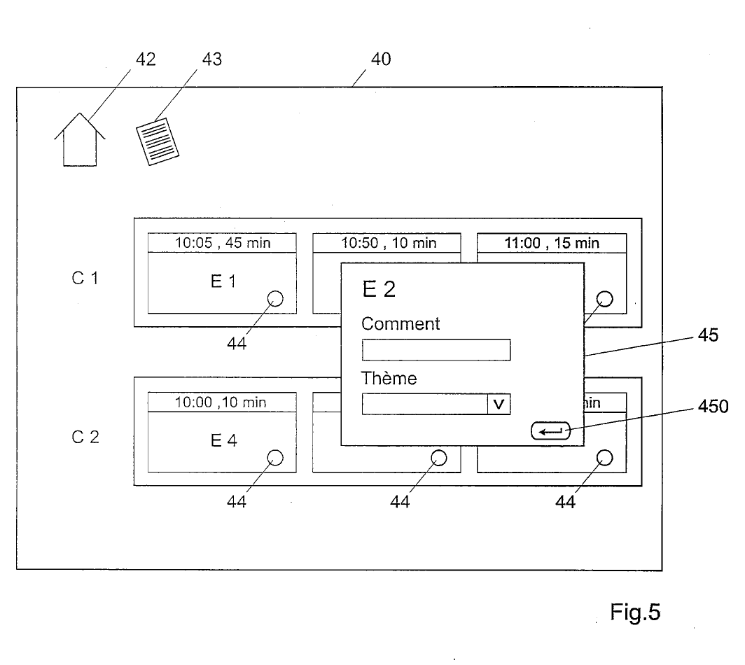

FIG. 5 illustrates an example of web page displayed when the user selects one of the buttons 44 to record one of the programs from the EPG, in this example the piece of video content or the program E2. A dialog box 45 or a new page opens in order to allow the user to enter a comment about the selected video content and to choose, from the list of themes the user can access, the one or ones with which an indication of content must be associated. The scheduled recording for all the users with a subscription to the theme is then initiated by selecting the button 450.

The server 1 includes a module 12 for remotely sending the instructions for programming the recorders to all the users with a subscription to themes including video contents that are to be broadcast soon. In one embodiment, instructions are only sent to users who can effectively receive the television channels in question. If the list of channels accessible to each user is not known to the server, it is also possible to send instructions to all the users who have subscribed to the themes in question and to ignore those instructions that cannot be executed at recorder level.

Similarly, possible conflicts between several video contents whose broadcast times overlap can be settled at the level of the server 1, for example according to criteria predefined or customized by the users. It is for example conceivable that each user should define the priorities according to the themes subscribed, the categories of video contents and/or the rankings given by the Internet users to the different items of video content. More complex criteria can be defined to limit the number of programs recorded; a user can for example decide upon a maximum number of items of video content or minutes of content that are to be recorded each day, globally and/or by category or by theme. These criteria can be verified either at the level of the server 1 or at the level of the recorder 5, 7, 9 or possibly at the level of the gateway 8.

The user can also define rules for managing the memory available on his recorder and for example define that a maximum 120 hours of video contents, or 200 gigabytes, or a maximum of 10 films, 3 hours of documentaries and the last three football matches recorded are to be kept. These management rules can be entered via the website shown by the server 1 or directly in the video recorder 5, 7, 9. They are then verified either by the server 1 or by the video recorder, and when one of them is fulfilled, a command for erasing the recording is sent by the server 1 and executed by the video recorder or directly executed by the video recorder, so as to automatically erase the video contents corresponding to the selected deletion criteria. Before erasing, a confirmation request can be displayed on the television set and asked of the user. In one embodiment, the older video contents and/or those that are less often watched or ranked lower by the users of the theme and/or those that have already been watched by the user and/or those that have not been explicitly protected against deletion are erased as soon as the available recording memory requires it.

The programming or erasing instructions sent by the server 1 are transmitted in digital form through the network 3 to the recorders 5, 7 and/or to the gateway 8. The instructions transmitted to the recorders 5, 7 can be sent in “push” mode, i.e. on the initiative of the server 1, or preferably in “pull” mode when the recorder 5, 7 verifies itself whether commands intended for it are available on the server 1. This verification can for example be performed each time the recorder is switched on, as soon as it comes out of standby mode and/or at periodic intervals.

The method and system of the invention advantageously includes an automatic recommendation system in order to propose to subscribing users additional themes or video contents. The automatic recommendation system can for example imply a correlation system between the users' choices in order to propose recommendations for example when they connect to the website of the server 1 or when they subscribe to a new theme or program a new video content in an existing theme. Recommendations can for example be of the following type:
The viewers with a subscription to this theme X have also often subscribed to theme Y.
Viewers who have scheduled the recording of this program have also sometimes programmed this other video content.
The program X seems to be about the same subject as program Y.
The three most programmed video contents for next week are a, b and c.
Etc.

The recommendations can also be based on computations of the distance between video contents, for example by using semantic algorithms and category analyses to analyze the descriptions of the video content and of the associated comments or metadata, to propose related video contents. If the analysis is performed at least partly at the level of the digital recorder or, if the server has a way of knowing which recorded video contents are effectively watched, the recommendations can also depend on watching the programs, for example in order to take into account differently the contents that have been watched several times and those that have not been watched to the end.

The server 1 and/or the gateway 8 can also automatically recommend new forms of subscription to television channels, for example when the user subscribes to themes that propose video contents broadcast by channels he cannot receive or decode. It is for example conceivable that the user receives a message or another advertising content that suggests he should subscribe to a television channel package on the topic of “sea and nature” if he often schedules the recording of programs on diving or if he subscribes to themes on this subject.

Similarly, it is also possible to propose to the user video contents on demand that correspond to his tastes when the broadcast system allows it. A user who regularly programs documentaries about diving or who enters comments on this topic could be invited to download onto his television or his recorder pay-to-view films on that subject or links to video, photo or other contents available on the Internet, for example on a site such as www.youtube.com.

Recommendations of video content, of themes, of subscriptions to new channel packages or to video-on-demand can be displayed on the web page presented by the server 1 when the user connects to this server. It is also possible to send such recommendations by email or by post if his email or post address has been indicated in his profile and if he has agreed to this type of advertising. Finally, it is also possible to display recommendations directly on the screen of the television sets 6, for example in the form of a personalized announcement or advertising content (text, image, video, hypertext link etc.) recorded on the recorders 7 and shown for example at the beginning, in the middle or at the end of a program. The advertising content can also be superimposed over the recorded video content or displayed in split screen fashion, etc.

In order to encourage users to communicate about the video contents, the web server can also propose to the theme administrators or to other users to create blogs hosted on the server 1 or elsewhere and relating to the created themes and to the programs on these themes. This is a way of reinforcing the community spirit around a theme. The blogs can be public or limited with access rights, for example by making them accessible only to users with a subscription to the themes concerned by these blogs.

The inventive server can be financed for example by cable operators who are interested in having users presented frequently with new video contents on channels to which they will be tempted to subscribe. In one embodiment, the subscription to at least certain themes can be charged, the amount charged being paid to the user who created the theme, to the operator of the server 1, to the cable operator and/or to the channels that broadcast the video contents selected in the theme. Sponsored themes are also conceivable; a paper magazine dedicated to diving could for example grant its readers access to a theme accessible through a code indicated in the magazine. Advertising linked to the sponsor of the theme could be displayed by the website in connection with each proposed theme.

It is also possible to finance this service at least party by displaying advertising on the website of the server 1 and/or advertising films added automatically by the server 1, the gateway 8 or the video recorder at the beginning, in the middle or at the end of the recorded video contents. Advertising can also be displayed dynamically be the recorder, for example when reading a video content, but without being stored with this content. The choice of the displayed advertisement will preferably depend on the user profile as defined in the server 1, notably the language, and/or the subscribed themes.

### REFERENCE NUMBERS USED IN THE FIGURES

1 Server
10 Database
11 Module enabling users to access remotely an EPG and/or the content of the database 10
12 Module allowing the command instructions for programming video recorders to be sent
3 Telecommunication network, for example Internet
4 Digital processing system of the users, for example computer
40 Web page
41 Theme creation dialog box
42 Icon for returning to the home page
43 Icon for accessing the EPG
44 Button or icon for selecting the program to be recorded
45 Dialog box for scheduling the recording of a program
5 Personal video recorder with bidirectional interface
50 Cell/battery of the logic model of the recorders
500 Physical layer
501 Drivers layer
502 Middleware layer
503 Applications layer
6 Television or display
60 Remote control
7 Personal video recorder with mono-directional interface
8 Gateway
9 Personal video recorder with direct access to Internet

1. A method for programming video recorders, comprising the following steps:
a piece of video content to be recorded is selected in an Electronic Program Guide by an editor-user of a video recorder,
an identification of said video content is included in a theme grouping one or more pieces of video content,
the users with a subscription to said theme are selected,
programming instructions of said piece of video content are automatically transmitted to the video recorders of the users with a subscription to said theme, the video recorders of said users being thus programmed without any intervention from the users.

2. The method of claim 1, wherein at least one editor-user is at the same time an editor selecting the video content of themes proposed to other users and a user whose video recorder is scheduled for recording programs included in themes managed by other editor-users.

3. The method claim 2, wherein a same video recorder is used for selecting the video content included in a theme and for recording the video content of other themes.

4. The method of claim 3, including a step during which said editor-user creating a theme defines a closed list of users who have the right to subscribe thereto.

5. The method of claim 4, including a step during which a user subscribes himself to a public theme or to a theme to which he has the right to subscribe.

6. The method of claim 2, including a step during which said editor-user creating a theme defines the rights of other users of the theme, wherein each user can be granted or refused at least one of the following rights:
the right to subscribe to the theme;
the right to add indications of video content to the theme;
the right to delete indications of video content of the theme;
the right to comment on a piece of video content;
the right to comment on a theme.

7. The method of claim 1, including a step of adding a comment or a rating to an item of video content selected in a theme.

8. The method of claim 7, including a step of searching for themes by means of a search tool on said server.

9. The method of claim 1, wherein a program executed by said server or in said digital recorder manages conflicts during the simultaneous programming of several pieces of video content.

10. The method of claim 9, wherein the user defines priorities associated to the themes to settle said conflicts.

11. The method of claim 1, wherein the user defines rules for choosing the video contents which are to be automatically erased from his recorder.

12. The method of claim 1, wherein a server sends programming command instructions to said video recorders in encrypted form.

13. The method of claim 1, including a step during which a user defines on a server a list of television channels to which he has access.

14. The method of claim 12, wherein said programming command instructions are transmitted via Internet to digital recorders directly connected to an Internet-type network.

15. The method of claim 12, wherein said programming command instructions are transmitted to at least one gateway at a cable operator that includes them in the video signal transmitted to the users.

16. The method of claim 1, including a step of adding advertising content associated to at least some recorded video contents.

17. A server for programming video recorders, having:
an electronic program guide;
a database for storing a list of themes grouping indications of video content and the user rights associated to this indications of video content;
an interface enabling the users to remotely modify the lists of themes and associated rights;
a module for automatically transmitting instructions to program video recorders in order to initiate the automatic recording of the video contents in each theme with the users who enjoy the corresponding rights, without intervention of said users.
